(19) United States
(12) Patent Application Publication
(10) Pub. No.: US 2015/0134730 A1
(43) Pub. Date: May 14, 2015

(54) METHOD FOR PERFORMING DNS RESOLUTION IN A NETWORK, CONTENT DISTRIBUTION SYSTEM AND CLIENT TERMINAL FOR DEPLOYMENT IN A CONTENT DISTRIBUTION SYSTEM

(71) Applicants: Jan Seedorf, Heidelberg (DE); Mayutan Arumaithurai, Goettingen (DE)

(72) Inventors: Jan Seedorf, Heidelberg (DE); Mayutan Arumaithurai, Goettingen (DE)

(73) Assignee: NEC EUROPE LTD., Heidelberg (DE)

(21) Appl. No.: 14/397,713

(22) PCT Filed: Apr. 30, 2012
(86) PCT No.: PCT/EP2012/057899

§ 371 Date: Oct. 29, 2014

(51) Int. Cl. H04L 29/12; H04L 29/06

(52) U.S. Cl. CPC H04L 61/106; H04L 67/42
USPC 709/203

(57) ABSTRACT

A method for performing DNS resolution in a network, in particular in a content distribution network (1), comprising a client terminal (2) sending a DNS request towards a DNS nameserver (3), and the DNS nameserver (3) responding to the DNS request by sending a DNS response towards the client terminal (2), is characterized in that within the DNS request information about the client terminal's (2) location together with dynamic status information of the client terminal (2) is conveyed to the DNS nameserver (3), wherein the DNS nameserver (3) generates the DNS response depending on said conveyed information about the client terminal (2). Furthermore, a corresponding content distribution system (1) and a client terminal (2) for deployment in a content distribution system (1) are disclosed.

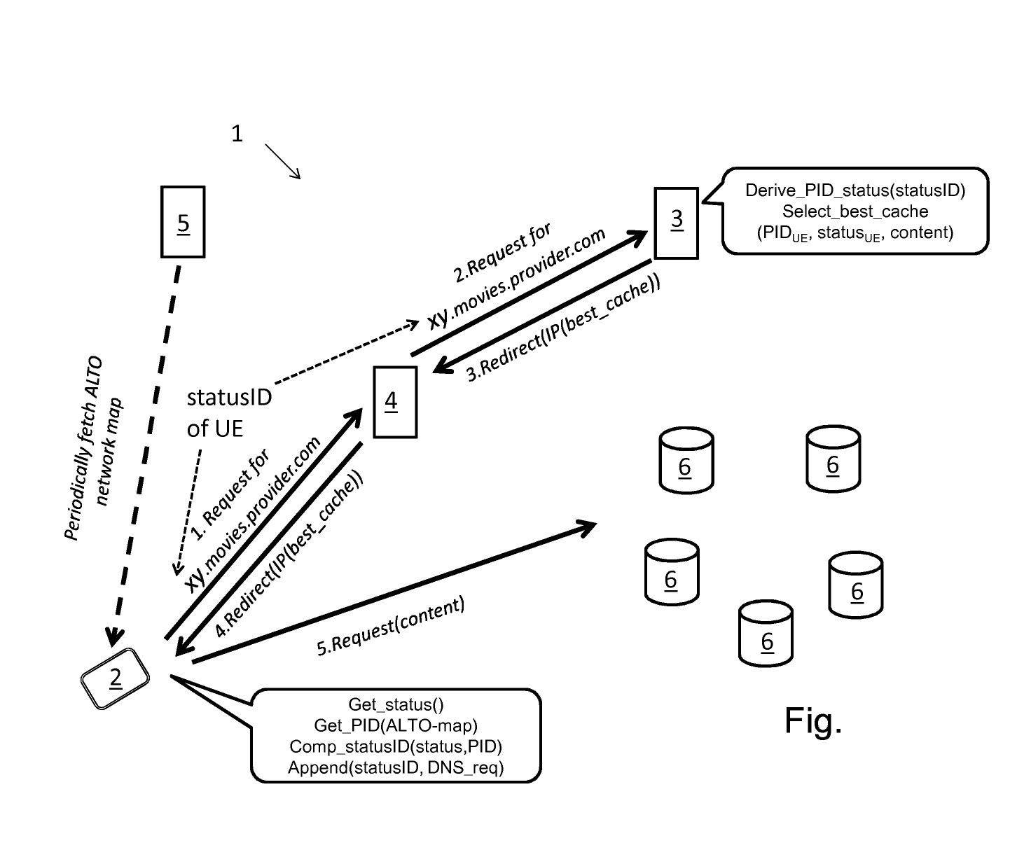

The present invention relates to a method for performing DNS resolution in a network, in particular in a content distribution network, comprising a client terminal sending a DNS request towards a DNS nameserver, and the DNS nameserver responding to the DNS request by sending a DNS response towards the client terminal.

Furthermore, the present invention relates to a content distribution system, comprising a DNS nameserver which is configured to respond to DNS requests from client terminals by sending a DNS response towards the client terminal.

Still further, the present invention relates to a client terminal for deployment in a content distribution system, comprising a DNS client which is enabled to send DNS requests towards a DNS nameserver and to retrieve DNS responses from the DNS nameserver.

Content delivery networks or content distribution networks (CDN) are large distributed systems of servers, which are used to store content and to provide or give access to that content for end users with high availability and high performance. The current content delivery networks are usually based on domain name resolution of hostnames via DNS (Domain Name System) to point a user to a most suitable server for accessing or download requested content.

A typical scenario in CDNs, but also in other scenarios, is that a DNS request for a certain domain is received by the authoritative DNS server which is controlled by the CDN responsible for the desired domain. In this regard, often the following problem arises: The DNS request does not come directly from the client terminal that has originally initiated the DNS request, but comes from an intermediate DNS resolver. Hence, the source IP-address of the DNS request received at the authoritative DNS server at most approximates the real location of the end user actually issuing the request (assuming that DNS resolvers are located close to users, which is not always the case).

This problem has already been described in the literature, for instance in C. Contavalli, W. van der Gaast, S. Leach, D. Rodden: “Client subnet in DNS requests”, draft-vandergaast-edns-client-subnet-00, Internet Draft (work in progress), July 2011]:

“Many Authoritative nameservers today return different replies based on the perceived topological location of the user. These servers use the IP address of the incoming query to identify that location. Since most queries come from intermediate recursive resolvers, the source address is that of the recursive rather than of the query originator.

Traditionally and probably still in the majority of instances, recursive resolvers are reasonably close in the topological sense to the stub resolvers or forwarders that are the source of queries. For these resolvers, using their own IP address is sufficient for authority servers that tailor responses based upon location of the querier.

Increasingly though a class of remote recursive servers has arisen that serves query sources without regard to topology. The motivation for a query source to use a remote recursive server varies but is usually because of some enhanced experience, such as greater cache security or applying policies regarding where users may connect. (Although political censorship usually comes to mind here, the same actions may be used by a parent when setting controls on where a minor may connect.) When using a remote recursive server, there can no longer be any assumption of close proximity between the originator and the recursive, leading to less than optimal replies from the authority servers.

A similar situation exists within some ISPs where the recursive servers are topologically distant from some edges of the ISP network, resulting in less than optimal replies from the authority servers.”

State-of-the-Art technology approximates the end user location by mapping the source IP-address of the DNS resolver of an incoming request (at the authoritative DNS server) to a region, assuming the end user client is in this region. As explained above, such approximations are increasingly suboptimal, due to the facts that a) users increasingly configure publically hosted DNS services, and b) recursive DNS resolvers used by ISPs are often not close to the end users.

To overcome this drawback it was proposed to modify the DNS protocol for resolving IP-addresses of hostnames by adding the client terminal's IP-address to the DNS-protocol, respectively the initial IP-address of the IP-resolving request, or by adding at least a sub-network identification information to allow identification of the region of the user to enhance IP-address resolution and enhanced guiding of the user to a more suitable server for download. However, in particular in CDN scenarios this information might still not be sufficient for enabling optimal surrogate/college selection.

It is therefore an object of the present invention to improve and further develop a method of the initially described type for performing DNS resolution in a network, as well as a content distribution system and a client terminal for deployment in a content distribution system of the initially described type in such a way that CDN request routing to be performed by the DNS nameserver is further optimized.

In accordance with the invention, the aforementioned object is accomplished by a method comprising the features of claim 1. According to this claim, such a method is characterized in that within the DNS request information about the client terminal's location together with dynamic status information of the client terminal is conveyed to the DNS nameserver, wherein the DNS nameserver generates the DNS response depending on said conveyed information about the client terminal.

Furthermore, the aforementioned object is accomplished by a content distribution system comprising the features of independent claim 16. According to this claim, such a system is characterized in that the DNS nameserver is further configured to receive information about the client terminal's location together with dynamic status information of the client terminal, and to generate the DNS response depending on said received information about the client terminal.

Still further, the aforementioned object is accomplished by a client terminal comprising the features of independent claim 21. According to this claim, such a client terminal is characterized in that within a DNS request information about the client terminal's location together with dynamic status information of the client terminal are conveyed to the DNS nameserver.

According to the invention it has been recognized that an improved DNS response, in particular an optimized CDN request routing, e.g. for optimal surrogate/cache selection, can be achieved by conveying to the DNS nameserver as much information about the requesting client terminal as possible. The more precise information a CDN has about the location of the client, the better it can optimize its internal CDN request routing mechanisms (i.e. the selection of the best cache to serve the request out of a multitude of candidate caches within the CDN). Without such information, the CDN can only guess about redirecting the DNS request received at the authoritative DNS server to the best cache location.

To this end, according to the invention, not only information about the location of the client terminal is conveyed to the DNS name server, but also (CDN-relevant) dynamically changing status information about the client terminal, thereby enabling CDN provider to exploit dynamically changing status information of client terminals within internal CDN request routing, despite a “transitive DNS resolving chain”. As a result, the CDN provider or upstream DNS servers are enabled to access information about the current status of the client terminal actually originating the request, such that more fine grained dynamic adaptation of CDN internal routing based on client terminal specifics is possible.

According to an embodiment in may be provided that the information about the client terminal is conveyed to the DNS nameserver via DNS options, e.g. DNS extensions, i.e. the information would be conveyed along the transitive DNS path. However, this would require modifications of existing DNS protocols, which are cost-intensive since all DNS-servers have to be provided with such a modification.

If in the whole chain of IP-address resolving requests only one DNS-server is not equipped with the above-mentioned modification of the DNS protocol the information about the client's location and/or status is lost for the other DNS-servers leading again to non-optimal resolution of the IP-address.

In order to avoid the above problem, according to a preferred embodiment it may be provided that the information about the client terminal is encoded within the client terminal's DNS request as a subdomain in the DNS tree. This comes along with the advantage that no modifications of existing DNS protocol specifications are required, since the subdomain can just be prepended to the requested domain, making it possible to work with regular DNS. In this regard it is further important to note that the proposed DNS encoding scheme (i.e. the computing and appending of the DNS prepending information) is performed at the terminal client, and not at intermediate nodes in the network; thus applying a DNS encoding scheme outside the operational domain of the network operator and getting information to authoritative DNS without explicit cooperation with network operators.

Advantageously, a predefined mapping scheme may be provided in which different status groups of possible client terminals' states are defined, wherein each status group is mapped to a predefined status ID, in particular in form of an alphanumeric identifier. Such mapping scheme would introduce flexible clustering possibility, which allows privacy-preserving groupings of dynamic location and client terminal properties in a scalable way. This means that the client terminal is associated to a predefined group based on the client terminal's current status such as link status, battery power, location, etc. It is to be understood that it could be the case that the client terminal is associated to a different group when its dynamic parameters change.

Additionally, a predefined mapping scheme of IP-prefix-ranges onto a predefined location ID may be provided, e.g. by the CDN provider. The location ID may be provided in form of an ALTO (Application-Layer Traffic Optimization) network map, following the ALTO service/protocol as specified in R. Alimi et al.:“ALTO Protocol”, draft-ietf-alto-protocol-10, Internet Draft (work in progress), October 2011, which is incorporated herein by way of reference. The generation and design of ALTO network maps is described in detail in section 4. of the document. In case of employing ALTO the location ID may be an ALTO PID (Provider-defined Network Location Identifier).

In a specific embodiment the mapping schemes may be provided by the CDN providers to the network operators who would in turn pass this information to the client terminals via a config file. The DNS client of the UEs could be configured to read this config file and accordingly append the respective identifier to outgoing DNS requests. The config files could provide a) a list of domain names for which the described scheme applies and b) a statusID and/or location ID mapping. Alternatively, the mapping schemes in principle also could be conveyed to the client terminals via ALTO. The ALTO server of the operator would fetch the available status-IDs and the PIDS served from the various CDN providers and create a network map consisting of the relevant mapping schemes that the client terminal could use and the CDN providers that use the schemes. An ALTO client on the client terminal would create the config file for the DNS client based on this information.

Regarding the proposed encoding scheme, it may be provided that the client terminal encodes within a DNS request its determined status ID, its determined location ID or an overall status ID generated by combining its status ID and its location ID as a subdomain in the DNS tree.

The DNS nameserver, upon receiving a DNS request, may respond to the request with a unique IP-address for each possible status-ID, location ID or overall status-ID. In particular, the overall status-ID provides detailed information about the client terminal, which enables the nameserver to optimize its response as far as possible and to redirect to the optimal cache depending on the status and location of the client terminal. Instead of answering with a unique IP-address, the nameserver may respond by providing a DNS CNAME in case of further redirection.

With respect to a preferred embodiment of a content distribution system, it may be provided that the DNS nameserver is an authoritative DNS nameserver. Applying the above scheme to a system with an authoritative DNS nameserver is particularly advantageous, since this kind of nameserver typically does not receive DNS requests directly from the querying client. Hence, in these cases the gain of information obtained by the nameserver is particularly high.

In content distribution systems with authoritative DNS nameservers there are typically intermediate DNS servers involved, in particular the DNS resolvers. Applying the above scheme to such a system has the added advantage that it enables the caching of answers from the authoritative DNS server for specific subdomains at the DNS resolver (or any other intermediate DNS server). Since the mapping of status-ID to DNS response (IP-address or CNAME redirection) applies to a whole class of client terminals (i.e. all client terminals with roughly that defined status), the DNS resolver may provide the response also for other requests to that subdomain in the future. The regular problems of DNS caching apply, i.e. the authoritative DNS server has to choose an adequate expiration time for each subdomain according to internals of the CDN (e.g. how often a change is to be expected).

Regarding the predefined mappings in form of the status-IDs described above, it may be provided that these identifiers are created to represent and classify the various possibilities of dynamically changing status information of the client terminal. Examples of such status information may include, but not limited to, e.g. information about the currently provisioned QoS (Quality of Service) in the (mobile) network in which the client terminal operates and/or information about the type of access network the client terminal is currently using (e.g. GPRS, 3G, 4G, WiFi, . . . ). Additionally or alternatively, status information may include information about the computational capabilities of the client terminal, in particular information regarding CPU, MEM, Operating System, supported codecs, and the like. Still further, status information may include information about the energy mode employed by the client terminal, e.g. whether the terminal is battery powered or whether access to power cable is available. Furthermore, the status information may include information regarding the costs incurring for the mobile terminal, e.g. in case of roaming, or whether there are any subscription inherent and restrictions, e.g. download limits.

There are several ways how to design and further develop the teaching of the present invention in an advantageous way. To this end it is to be referred to the patent claims subordinate to patent claims 1, 16, and 21 on the one hand and to the following explanation of preferred embodiments of the invention by way of example, illustrated by the FIGURE on the other hand. In connection with the explanation of the preferred embodiments of the invention by the aid of the FIGURE, generally preferred embodiments and further developments of the teaching will we explained. In the drawing the only

FIGURE is a schematic view illustrating a content distribution system according to an embodiment of the present invention.

The FIGURE shows a content distribution network CDN 1 according to an embodiment of the present invention. Although the illustrated embodiment targets specifically a mobile network, where detailed information about the client terminal is crucial for optimal CDN request routing, in principle, the present invention also applies to fixed networks; in fixed network, however, it seems unlikely that modifications of the DNS client and config updates could be provisioned transparently to the user in the sense that the user is not providing its consent to the described local OS/DNS add-ons. Nevertheless, this does not prevent applicability of the invention in fixed networks at all.

In the illustrated embodiment the client terminal is a mobile phone, denoted UE (User Equipment) 2. As will be easily appreciated by those skilled in the art, any of the mobile communication device may function as client terminal, e.g. a smart phone, a laptop, or the like. The nameserver is an authoritative DNS nameserver 3 for the domain movies.provider.com. An intermediate nameserver, which in the illustrated embodiment is a DNS resolver 4, is located between the UE 2 and the authoritative DNS nameserver 3. It is to be understood that for simplification and clarification purposes only a single UE 2 is depicted in the FIGURE, which represents a plurality of UEs that would contact the same authoritative DNS nameserver 3 in a realistic scenario.

In the illustrated embodiment it is assumed that predefined mappings (status-IDs) consisting of an alphanumeric identifier are created to represent and classify the various possibilities of dynamically changing status information of the UEs 2. The UEs 2 are expected to locally collect available status information and map it to one of the provided status-IDs.

In practice, such mappings could be provided by the CDN providers to the network operators who would in turn pass this information to the UEs 2 via a config file. The DNS client of the UEs 2 could be configured to read this config file and accordingly append the status-id to outgoing DNS requests. Such config files would provide a) a list of domain names for which the described scheme applies and b) a status-ID mapping. An example for a simple status-ID mapping could look like this:

| | Computational | |
|---|---|---|
| Access network | Capabilities | STATUS-ID |
| Low (<=384 kb/s download capacity) | Low | 1 |
| Low (<=384 kb/s download capacity) | Medium | 2 |
| Low (<=384 kb/s download capacity) | High | 3 |
| Medium (<=2 Mb/s download capacity) | Low | 4 |
| Medium (<=2 Mb/s download capacity) | Medium | 5 |
| Medium (<=2 Mb/s download capacity) | High | 6 |
| High (>2 Mb/s download capacity) | Low | 7 |
| High (>2 Mb/s download capacity) | Medium | 8 |
| High (>2 Mb/s download capacity) | High | 9 |

These mappings are expected to have a long lifetime, but need not be static and can be changed when required.

In addition, optionally, the CDN provider might provide a predefined mapping of IP-prefix-ranges onto an identifier, e.g. in form of an ALTO-map (as described in R. Alimi et al.:“ALTO Protocol”, draft-ietf-alto-protocol-10, Internet Draft (work in progress), October 2011). Such an ALTO map could be made available via an ALTO server 5 hosted by the CDN provider and provide an ALTO network map that could be periodically fetched by the UE 2. The UE 2 can use this ALTO network map to map its current IP-address onto an ALTO “PID”, i.e. an abstract identifier. An example of an ALTO network map could look like this:

{

“meta” : { },
“data” : {

“map-vtag” : “1266506139”,
“map” : {

“PIDA” : {

“ipv4” : [

“192.0.2.0/24”,
“198.51.100.0/24”

]

},
“PIDB” : {

“ipv4”: [

“198.51.100.128/24”

]

}

}

}

}

In case the UE 2 does not find its current IP-address in the ALTO network map (e.g. in cases the ALTO network map does not cover the whole world and the UE 2 has moved to a different country/region not covered by the ALTO-PID-mapping), a default PID for unknown is used, e.g. “U”. It is noted that normally ALTO network maps contain such a “rest-of-IP-address-space” to default PID mappings.

The UE 2 appends the status ID and, optionally, the ALTO PID it determined as described above to obtain an overall status ID, which hereinafter is denoted DYNAMIC-ID. For instance, such a combined DYNAMIC-ID could look like “6B”, indicating—following the previous examples—that the UE 2 has “high” computational capabilities“, a “medium” speed connection, and is currently located in PID “B”.

When the UE's 2 DNS client receives a local DNS request from an application, it first checks in the latest config file (e.g. received from the operator) if the FQDN (Full Qualified Domain Name) in the request is applicable for the scheme. This is the case when content for this domain is delivered by a certain CDN. Next, if the FQDN applies to the scheme, the UE 2 fetches its overall status ID—DYNAMIC-ID—which the UE 2 may frequently compute and may have available in local memory.

In a next step, the DNS client of the UE 2 appends the determined status ID or the overall DYNAMIC ID (e.g. “6B”) as a subdomain to the FQDN it received locally to obtain FQDN+. In other words, the DNS client queries for FQDN+, i.e. for the FQDN the application requested with the status ID appended as a subdomain. This request is transmitted to the DNS resolver 4, which is illustrated in step 1. of the FIGURE it is noted that iln the illustrated embodiment the subdomain is xy which is prepended to the FQDN movies.provider.com.

The DNS resolver 4 forwards the request to the authoritative DNS nameserver 3 (step 2. in the FIGURE). The DYNAMIC-ID provides detailed information about the UE 2. For each possible DYNAMIC-ID the authoritative DNS nameserver 3 can potentially answer with a unique IP-address (or DNS CNAME in case of further redirection). This enables the authoritative DNS nameserver 3 to redirect to the optimal cache depending on the status and location of the UE 2. The thus generated response this send to the DNS resolver 4 (step 3. in the FIGURE), which forwards the response to the UE 2 (step 4. in the FIGURE). Upon receipt of the response, the UE 2 can request the desired content from a cache 6 out of a plurality of candidate caches 6, which best fits the UE's 2 current status.

As will be appreciated by those skilled in the art the described scheme also works in case of more than one CDN provider. In this case, the UE 2 is not only provided with a single list of FQDN to which the scheme applies and a single status ID mapping scheme, but in addition the UE 2 is provisioned (e.g. through config files) with 1) a status-ID mapping for each CDN and 2) the FQDN list contains information which mapping is to be used for which FQDN (i.e. which domain is served by which CDN). In case of different CDN providers, each provider can convey his own scheme to the client terminals.

It is further noted that the mapping scheme and FQDN list in principle also could be conveyed to the UE 2 via ALTO. For the purpose the ALTO server 5 of the operator would fetch the available status IDs and the PIDS served from the various CDN providers and create a network map consisting of the relevant mapping schemes that the UE 2 could use and the CDN providers that use the schemes. The ALTO client on the UE 2 would create the config file for the DNS client based on this information. An example of an ALTO network map could look like this (providing information which mapping is to be used for which FQDN):

{

“meta” : { },
“data” : {

“map-vtag” : “1266506139”,
“map” : {

“DYNAMIC-ID-SCHEME-1” : {

“ipv4” : [

“CDN provider 1”,
“CDN provider 2”

]

},
“DYNAMIC-ID-SCHEME-2” : {

“ipv4”: [

“CDN provider 1”,
“CDN provider 3”

]

}

}

}

}

Independent of how the FQDN list for which the scheme applies and the mapping scheme for computing the status ID is conveyed to the UE 2, the UE 2 may have a modified DNS client (or equivalent hook in the OS of the UE 2 that allows to modify DNS requests queried by applications) and that this modified software can frequently be updated with latest config files (or ALTO maps in case of ALTO). This assumption seems reasonable for mobile networks, where the operator is capable of updating the UE's 2 operating systems in the necessary way.

Alternatively or additionally, the UE 2 may have applications running (“apps”) which apply the scheme themselves within their DNS requests (i.e. on a per-app level). In other words, changing the DNS client of the OS is not necessary, even just changing single “apps” is sufficient if those apps are the ones predominantly using a certain content provider (e.g. YouTube). The apps could also be configured with the status mapping information or be configured to fetch it from the respective servers instead on an ALTO server.

As will be appreciated by those skilled in the art with the described status ID mapping according to an embodiment of the invention different levels of granularity are possible, i.e. the range of the mapping function can be chosen. The desired granularity can be selected by the CDN provider. In practice, it is likely that a mapping onto a rough status (as in the examples above) provides enough information for the CDN provider to optimize its internal request routing. In general, the tradeoff here is that a finer granularity provides more detailed information to the CDN provider at the cost of more subdomains to maintain in the DNS tree. Too many subdomains (i.e. a very high granularity) might have the drawback that caching of DNS responses at DNS intermediaries is less effective, as re-using a cached entry is less likely the more detailed the status of UEs is differentiated.

It is important to note that—in contrary to existing DNS encoding schemes—the proposed scheme according to an embodiment of the invention is applied outside the domain of the network operator. In particular, the explicit encoding of status information in DNS requests in form of subdomains is completely performed by the terminal clients themselves. Thus, the scheme can be used without explicitly involving or without the consent of a (mobile) network operator. The scheme is thus applicable and very useful in scenarios where the CDN provider is outside of the mobile network(s) domain (such as roaming, CDN interconnection, or network access via non-3GPP interfaces such as WiFi); it enables getting information to the authoritative DNS server without explicit/detailed cooperation between network operator and CDN provider.

It is further noteworthy to point out that the proposed scheme is very useful for CDN Interconnection, where an upstream CDN provider has to select a suitable downstream CDN provider which can best serve a given request for content. Based on the DYNAMIC-ID sent by the UE, the upstream CDN would be able to optimize the downstream CDN selection based on location as well as status information, e.g., a downstream CDN server that is closest to the UE via its 3GPP connection and has the required data in a lower quality.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for performing DNS resolution in a network, in particular in a content distribution network (1), comprising:
a client terminal (2) sending a DNS request towards a DNS nameserver (3), and the DNS nameserver (3) responding to the DNS request by sending a DNS response towards the client terminal (2),
characterized in that within the DNS request information about the client terminal's (2) location together with dynamic status information of the client terminal (2) is conveyed to the DNS nameserver (3), wherein the DNS nameserver (3) generates the DNS response depending on said conveyed information about the client terminal (2).

2. Method according to claim 1, wherein said information about the client terminal (2) is conveyed to the DNS nameserver (3) via DNS extensions, or
wherein said information about the client terminal (2) is encoded within the client terminal's (2) DNS request as a subdomain in the DNS tree.

3. (canceled)

4. Method according to claim 1, wherein a mapping scheme is provided in which different status groups of possible client terminals' (2) states are defined, wherein each status group is mapped to a predefined status ID, in particular in form of an alphanumeric identifier, or
wherein a mapping scheme is provided in which IP-prefix-ranges are defined, wherein each range is mapped to a predefined location ID, in particular in form of an ALTO PID.

5. (canceled)

6. Method according to claim 4, wherein the mapping scheme is provided to the client terminals (2) via a configuration file to be executed by the client terminals' (2) DNS clients, and/or
wherein the mapping scheme is provided by a CDN provider and conveyed to the client terminals (2) via a network operator or via an ALTO server (5).

7. (canceled)

8. Method according to claim 4, wherein a client terminal (2) encodes within a DNS request its determined status ID, its determined location ID or an overall status ID generated by combining its status ID and its location ID as a subdomain in the DNS tree.

9. Method according to claim 4, wherein the DNS nameserver (3) responds to a DNS request with a unique IP-address for each possible status ID, location ID or overall status-ID,
wherein responses from the DNS nameserver (3) are preferably cached at intermediate DNS servers.

10. (canceled)

11. Method according to claim 1, wherein the dynamic status information of the client terminal (2) includes information about the currently provisioned QoS, and/or
wherein the dynamic status information of the client terminal (2) includes information about the type of access network the client terminal (2) is using, and/or
wherein the dynamic status information of the client terminal (2) includes information about the client terminal's (2) computational capabilities, and/or
wherein the dynamic status information of the client terminal (2) includes information about the client terminal's (2) energy mode, and/or
wherein the dynamic status information of the client terminal (2) includes information about costs of network usage incurring for the client terminal (2).

12. (canceled)

13. (canceled)

14. (canceled)

15. (canceled)

16. Content distribution system, comprising
a DNS nameserver (3) which is configured to respond to DNS requests from client terminals (2) by sending a DNS response towards the client terminal (2),
characterized in that the DNS nameserver (3) is further configured
to receive information about the client terminal's (2) location together with dynamic status information of the client terminal (2), and
to generate the DNS response depending on said received information about the client terminal (2).

17. System according to claim 16, wherein the DNS nameserver (3) is an authoritative DNS nameserver (3).

18. System according to claim 17, wherein at least one intermediate DNS resolver is provided between the client terminals (2) and the authoritative DNS nameserver (3),
wherein said at least one intermediate DNS resolver is preferably configured to cache DNS responses from the authoritative DNS nameserver (3) for different status groups of possible client terminals' (2) states.

19. (canceled)

20. System according to claim 16, further comprising an ALTO server (5) which is configured to provide an ALTO network map to client terminals (2).

21. Client terminal for deployment in a content distribution system, comprising a DNS client which is enabled to send DNS requests towards a DNS nameserver (3) and to retrieve DNS responses from the DNS nameserver (3),
characterized in that within a DNS request information about the client terminal's location together with dynamic status information of the client terminal are conveyed to the DNS nameserver (3).

22. Client terminal according to claim 21, wherein the DNS client and/or an application running on the client terminal is configured to collect available status information.

23. Client terminal according to claim 21, wherein the DNS client and/or an application running on the client terminal is configured to receive via a configuration file predefined mappings between different status groups of possible client terminals' states and a status ID, in particular in form of an alphanumeric identifier, and/or
wherein the DNS client and/or an application running on the client terminal is configured to fetch from an ALTO server (5) an ALTO network map which is used to map the current IP-address of the client terminal to a predefined location ID, in particular in form of an ALTO PID.

24. (canceled)

25. Client terminal according to claim 23, wherein the DNS client and/or an application running on the client terminal is configured to map the available status and/or location information to one of the provided status IDs and/or location IDs, and/or
wherein the DNS client and/or an application running on the client terminal is configured to encode the computed status ID and/or location ID within outgoing DNS requests as a subdomain in the DNS tree.

26. (canceled)
